(19) United States
(12) Patent Application Publication
(10) Pub. No.: US 2002/0065791 A1
(43) Pub. Date: May 30, 2002

(54) Control system conversion method

(76) Inventor: David P. Magee, Plano, TX (US)

Correspondence Address: TEXAS INSTRUMENTS INCORPORATED, P O BOX 655474, M/S 3999, DALLAS, TX, 75265

(21) Appl. No.: 09/948,483

(22) Filed: Sep. 5, 2001

Related U.S. Application Data
(60) Provisional application No. 60/230,471, filed on Sep. 6, 2000.

(51) Int. Cl. G06N 7/08

(52) U.S. Cl. 706/59

(57) ABSTRACT

A method transforms any linear control system into its estimator/regulator equivalent(s) and also may select from such equivalents a particular one pursuant to additional one or more criteria. The transformation can be found from solutions to a quadratic matrix equation.

### CROSS REFERENCE TO RELATED APPLICATIONS

This application claims priority from provisional application Ser. No. 60/230,471, filed Sep. 6, 2000.

### BACKGROUND OF THE INVENTION

1. Field of the Invention

The invention relates to control system design.

2. Background of the Invention

Many different techniques exist for designing a control system to govern the performance of a particular plant. For an acceptable level of performance to be achieved, the control system will need to monitor the behavior of various states in the plant. Some of these responses can be measured with sensors, but for many applications, not all of the states can be measured. When unmeasured states are required, a mathematical estimator is designed and incorporated into the control system. Then, a regulator is designed using these measured and estimated states to produce a control system that governs the system to within the performance specifications. Generally see Franklin et al, Digital Control of Dynamic Systems (Addison-Wesley, 2d Ed 1990)

Unfortunately, most design methods for an estimator/regulator cannot guarantee control system properties such as stability margins or open loop crossover frequency. Therefore, they must be iterated until a control system with acceptable properties has been found. These steps can be very time consuming and, depending on the complexity of the problem, can make convergence to an acceptable control system architecture very difficult.

Many times it is easier to design a control system using one technique and then map the result into another form. For example, an engineer might have experience with classical control systems and can shape a series filter to achieve the necessary stability margins and bandwidth. However, the engineer would also like to have state estimates of the system to perform other functions such as trajectory planning. This is a problem.

Known design procedures provide for a control system certain requirements and can express them in the state space form

\dot{x}_{d}=A_{d}x_{d}+B_{d}y+F_{d}r (1)

U=C_{d}x_{d}+D_{d}y+G_{d}r

where the “d” subscript denotes the target desired controller, x_{d} is an n×1 vector of desired controller states, y is a p×1 vector of plant measurements used by the controller, r is a q×1 vector of reference inputs to the controller, u is an m×1 vector of outputs from the controller and A_{d} is an n×n matrix of coefficients, B_{d} is an n×p matrix of coefficients, C_{d} is an m×n matrix of coefficients, D_{d} is an m×p matrix of coefficients, F_{d} is an n×q matrix of coefficients, and G_{d} is an m×q matrix of coefficients.

It is also assumed that a model of the plant exists and can be written in the state space form

\dot{x}_{d}=Ax+Bu (2)

y=Cx

where x is an n×1 vector of plant states, u is an m×1 vector of inputs to the plant, y is a p ×1 vector of plant measurements and A is an n×n matrix of coefficients, B is an n×m matrix of coefficients, and C is a p×n matrix of coefficients. The problem is then to formulate a prediction estimator or current estimator version of the target desired control system.

While the foregoing have been expressed in continuous-time notation, for a discrete-time representation of the solution, integrate the first order matrix differential equations over a sample period and then discretize the equations. That is, x→x[n], \dot{x}→x[n+1], A→e^{AT} with T as the sampling period, et cetera.

### SUMMARY OF THE INVENTION

The invention provides a method for mapping a target desired control system into an equivalent estimator/regulator form, both prediction estimator and current estimator.

### BRIEF DESCRIPTION OF THE DRAWINGS

The drawings are heuristic for clarity.

FIG. 1 illustrates a prediction estimator/regulator control system.

FIG. 2 illustrates a current estimator/regulator control system.

FIG. 3 shows experimental results for a random seek test.

### DETAILED DESCRIPTION OF THE PREFERRED EMBODIMENTS

1. Overview

The preferred embodiments construct mappings of given control systems into equivalent estimator/regulator forms by solving a quadratic matrix equation that arises from coefficients of the given control systems and the plant models. The resulting equivalent estimator/regulator forms have the same input/output relationship but contain different internal dynamics. When a preferred embodiment generates multiple equivalent estimator/regulator forms for a given control system, optimization with respect to one or more additional criteria may be invoked to select a design from the set of equivalent estimator/regulator forms.

2. Prediction estimator preferred embodiments

This section presents the mathematical development for matching a prediction estimator/regulator control system to a state space representation of a target desired control system. The result of the derivation is a quadratic matrix equation whose solution is a special transformation matrix that maps between the target desired controller form and the regulator/estimator form. With this matrix, the estimator and regulator gain matrices can then be determined. The solution is general in nature and is applicable to single input-single output (SISO) and multiple input-multiple output (MIMO) systems.

A general form for a prediction estimator can be written as

\dot{x}ₚ=Axₚ+Bu+Lₚ(y−cxₚ) (3)

u=−Kₚxₚ−Jₚy

where xₚ is an n×1 vector of prediction estimator states, Lₚ is an n×p matrix of prediction estimator gains, Kₚ is an m×n matrix of regulator gains, and Jₚ is an m×p matrix of feedforward gains. This form extends the classical design by including a feedforward term in the output equation so that a more general controller can be designed.

The fundamental dynamics of the controller are represented by the foregoing equations but it does not contain a reference input. In most applications, the control system must enable the plant to respond to a desired input command. However, there are many different configurations that exist for incorporating a reference input into an estimator/regulator control structure. The form that is proposed here is general so that different forms can be generated depending on the control system application.

If a scaled version of the reference input is added to each equation, the resulting prediction estimator/regulator dynamics become

\dot{x}ₚ=(A−BKₚ−LₚC) xₚ+(Lₚ−BJₚ)y+Mₚr (4)

u=−Kₚxₚ−Jₚy+Nₚr

where Mₚ is an n×q matrix relating the reference inputs to the state estimates and Nₚ is an m×q matrix relating the reference inputs to the controller outputs. These equations can be represented in block diagram form as shown in FIG. 1. The first observation is that, in general, the input to the estimator is different than the input to the plant, P(s). As a result, the estimator pole dynamics can influence the transient response of the overall system. An obvious solution to this problem is to set Nₚ=0 so that the estimator and the plant have the same input.

But there are many possible choices for MP and Np, most of which are determined by the desired controller form. For example, a more general solution to the problem of estimator excitation can be found by examining the dynamic equations describing the estimator error x−xₚ. Subtracting \dot{x}ₚ. from \dot{x} produces

\dot{x}−\dot{x}ₚ=(A−LₚC) (x−xₚ)+(BNₚ−Mₚ)r. (5)

Notice that when Mₚ=BNₚ, the error dynamics are independent of the reference input, which implies that the input does not excite error in the estimator.

In many applications, only the error between the plant measurement and the reference input is important. By setting Nₚ=Jₚ and Mₚ=BJₚ−Lₚ, the prediction estimator and regulator equations become

\dot{x}ₚ=(A−BKₚ−Lₚ C) xₚ+(BJₚ−Lₚ)e (6)

u=−Kₚxₚ+Jₚe

where e=r−y. This form aligns well with classical feedback control where the error signal is the input to the controller and the input/output relationships for the reference input r and the controller inputy are the same.

Given the prediction estimator/regulator control system as in the foregoing equations with reference input, the objective is to solve for the Jₚ, Kₚ, Lₚ, Mₚ and Nₚ gain matrices so that these dynamics are the same as the desired controller dynamics. One way to achieve this objective is to assume that the states for the estimator/regulator and the states for the desired controller are both in the range space of a third state space system. When this condition holds, a transformation exists between each form of the controller, and the corresponding gains can be determined.

For example, define a new n-dimensional state vector z such that

xₚ=Tₚz (7)

and

x_{d}=T_{d}z (8)

where the n×n matrix Tₚ reveals how the states of the prediction estimator can be written as a function of the new state vector and the n×n matrix T_{d} reveals how the states of the desired controller can be written as a function of the new state vector.

Substituting the definition of Tₚ into the prediction estimator/regulator dynamics equation produces the n×n matrix equations

\dot{z}=Tₚ⁻¹(A−BKₚ−LₚC) Tₚz+Tₚ⁻¹(Lₚ−BJₚ)y+Tₚ⁻¹Mₚr (9)

u=−KₚTₚz−Jₚy+Nₚr

and similarly substituting the definition of T_{d} into the equation for the desired control system produces

\dot{z}=Tₚ⁻¹A_{d}T_{d}z+T_{d}⁻¹ B_{d}y+T_{d}⁻¹F_{d}r (10)

u=C_{d}T_{d}z+D_{d}V+G_{d}r

By assuming that these two sets of equations are equivalent, the following relationships

T_{d}⁻¹A_{d}T_{d}=Tₚ⁻¹(A−BKₚ−LₚC)Tₚ (11)

T_{d}⁻¹B_{d}=Tₚ⁻¹(Lₚ−BJₚ)

T_{d}⁻¹F_{d}=Tₚ⁻¹Mₚ

C_{d}T_{d}=−KₚTₚ

D_{d}=−Jₚ

G_{d}=Nₚ

can be determined by simply equating like matrices in the state space representations. Defining T₁=T_{d}Tₚ⁻¹, the equations simplify to

A_{d}T₁+B_{d}C−T₁(A+BD_{d}C) −T₁BC_{d}T₁=0 (12)

Jₚ=−D_{d}

Kₚ=−C_{d}T₁

Lₚ=T₁⁻¹B_{d}−BD_{d}

Mₚ=T₁⁻¹F_{d}

Nₚ=G_{d}

By solving the quadratic equation with n×n matrices

A_{d}T₁+B_{d}C−T₁(A+BD_{d}C)−T₁BC_{d}T₁=0 (13)

for the T₁ matrix, the gain matrices (Jₚ, Kₚ, Lₚ, Mₚ and Nₚ) can be computed using the foregoing equations. To solve for the unknown T₁ matrix, first define the 2 n×2 n Hamiltonian-like matrix H:

$$H = [ \begin{matrix}A + B {D}_{d} C & B {C}_{d} \\ {B}_{d} C & {A}_{d}\end{matrix} ]$$

then the equation for the T₁ matrix can be written as:

$$[ \begin{matrix}- {T}_{1} & I\end{matrix} ] H [ \begin{matrix}I \\ {T}_{1}\end{matrix} ] = 0$$

Now if V is an n-complex dimensional H-invariant subspace of 2n-complex dimensional space and two n×n matrices V₁ and V₂ can be found so that V is the span of the n column vectors of

$$[ \begin{matrix}{V}_{2} \\ {V}_{1}\end{matrix} ] ,$$

and V₂ is invertible, then T₁=V₁V₂¹is a solution. Indeed, if such V exists, then H-invariance means there exists some n×n matrix X such that

$$H [ \begin{matrix}{V}_{2} \\ {V}_{1}\end{matrix} ] = [ \begin{matrix}{V}_{2} \\ {V}_{1}\end{matrix} ] X$$

because each of the columns of

$$[ \begin{matrix}{V}_{2} \\ {V}_{1}\end{matrix} ]$$

must map into a linear combination of these n columns, and the n coefficients of a column of X define such a linear combination. Lastly, there are n image linear combinations of the columns of

$$[ \begin{matrix}{V}_{1} \\ {V}_{2}\end{matrix} ] ,$$

so n columns in X suffice.

Post-multiplying by V₂⁻¹ yields

$$H [ \begin{matrix}I \\ {V}_{1} {V}_{2}^{- 1}\end{matrix} ] = [ \begin{matrix}I \\ {V}_{1} {V}_{2}^{- 1}\end{matrix} ] {V}_{2} X {V}_{2}^{- 1}$$

Then pre-multiplying by

$$⌊ \begin{matrix}- {V}_{1} {V}_{2}^{- 1} & I\end{matrix} ⌋$$

makes the righthand side equal to 0 and shows T₁=V₁V₂⁻¹ is a solution.

Of course, this solution procedure requires the existence of such invariant subspaces V, but a V can be found by spectral analysis of H. In particular, linear combinations of (generalized) eigenvectors define invariant subspaces. In summary, the procedure has the following steps:

(1) Given a plant model plus desired controller, both in n-dimensional state space form, for the 2n×2n matrix H as above.

(2) Determine eigenvalues and (generalized) eigenvectors of H; there are at most 2n eigenvalues.

(3) Form n dimensional H-invariant subspaces as spans of sets of the eigenvectors; the number could be as large as

$$( \begin{matrix}2 n \\ n\end{matrix} ) .$$

(4) For each H-invariant subspace (spanned by n 2n-dimensional vectors νⱼ₁, νⱼ₂ , . . . , νⱼₙ) check the rank of the n×n matrix ν₂ with columns formed from the first n components of the vectors νⱼ₁, νⱼ₂, . . . , νⱼₙ. and similarly check the rank of the n×n matrix V₁with columns formed from the last n components of the vectors νⱼ₁, νⱼ₂, . . . , νⱼₙ. If these ranks are both equal to n, then compute the n×n matrix T₁ as V₁V₂⁻¹.

(5) Compute the gain matrices for the estimator/regulator using T₁. In order to have a T ₁with real values, the invariant subspace V must be conjugate symmetric. In general there are many solutions T₁ to the quadratic matrix equation. And each solution leads to corresponding estimator/regulator gain matrices that will have dynamics equivalent to that of the desired controller. Thus, when multiple equivalent estimator/-regulator forms are generated for a given control system, optimization with respect to one or more additional criteria may be invoked to select a design from the set of equivalent estimator/regulator forms.

3. Current estimator preferred embodiments

This section presents the mathematical development for matching a current estimator/regulator control system to a state space representation of a desired control system. The result of the derivation is a quadratic equation whose solution is a special transformation matrix that maps between the desired controller form and the regulator/estimator form. With this matrix, the estimator and regulator matrix gains can then be determined. The solution is general in nature and is applicable to SISO and MIMO systems.

A general form for a current estimator can be written as

x_{c}=xₚ+L_{c}(y−Cxₚ) (14)

\dot{x}ₚ=Ax_{c}+Bu

u=−K_{c}x_{c}−J_{c}Y

where x_{c} is an n×1 vector of current estimator states, xₚ is an n×1 vector of prediction estimator states, L_{c} is an n×p matrix of current estimator gains,K_{c} is an m×n matrix of regulator gains and J_{c} is an m×p matrix of feedforward gains. This form extends the classical design by including a feedforward term in the output equation so that a more general controller can be designed.

The fundamental dynamics of the controller are represented by the equations but do not contain a reference input. In most applications, the control system must enable the plant to respond to a desired input command. However, there are many different configurations that exist for incorporating a reference input into a estimator/regulator control structure. The form that is proposed here is general so that different forms can be generated depending on the control system application.

After adding a scaled version of the reference input to the current estimator/ regulator equations, the dynamics become

x_{c}=xₚ+L_{c}(y−Cxₚ) (15)

\dot{x}ₚ=(A−BK_{c})x_{c}−BJ_{c}y+M_{c}r

u=−K_{c}x_{c}−J_{c}y+N_{c}r

where M_{c} is an n×q matrix relating the reference inputs to the state estimates and N_{c} is an m×q matrix relating the reference inputs to the controller outputs.

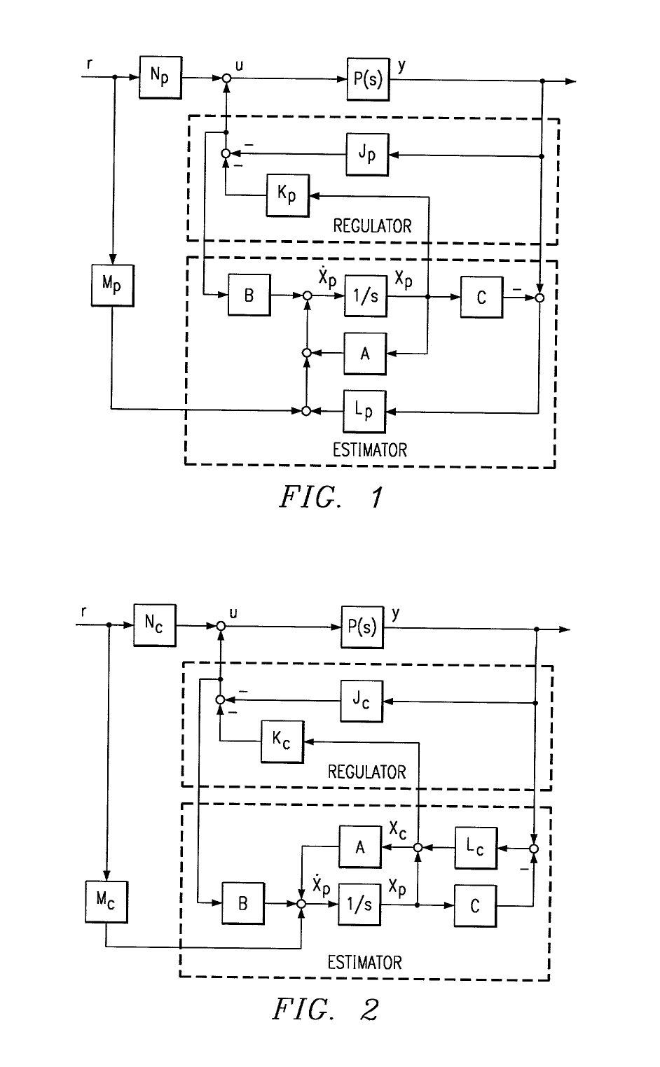

These equations can be represented in block diagram form as shown in FIG. 2. The first observation is that, in general, the input to the estimator is different than the input to the plant, P(s). As a result, the estimator pole dynamics can influence the transient response of the overall system. An obvious solution to this problem is to set N_{c}=0 so that the estimator and the plant have the same input.

But there are many possible choices for M_{c} and N_{c}, most of which are determined by the desired controller. For example, a more general solution to the problem of estimator excitation can be found by examining the dynamic equations describing the estimator error x−x_{c}. Subtracting \dot{x}_{c} from \dot{x} produces

$$\dot{x} - {\dot{x}}_{c} = ( I - {L}_{c} C ) A ( x - {x}_{c} ) + ( I - {L}_{c} C ) ( B {N}_{c} - {M}_{c} ) r \qquad ( 16 )$$

Notice that when M_{c}=BN_{c}, the error dynamics are independent of the reference input which implies that the input does not excite error in the estimator.

In many applications, only the error between the plant measurement and the reference input is important. To formulate this condition, the current estimator/regulator dynamics must be written as

\dot{x}_{c}=(I−L_{c}C)(A−BK_{c}) x_{c}−(I−L_{c}C) BJ_{c}y+L_{c}\dot{y}+(I−L_{c}C)M_{c}r (17)

u=−K_{c}x_{c-J}_{c}y+N_{c}r

to reveal the dynamics of just the current estimator states. Defining a new state vector as

xₙ=(I−L_{c}C)⁻¹ x_{c}−(I−L_{c}C)⁻¹ L_{c}y, the controller dynamics can be rewritten as

\dot{x}ₙ=(A−BK_{c})(I−L_{c}C)xₙ+((A−BK_{c}) L_{c}−BK_{c})L_{c}−BJ_{c})y+M_{c}r (18)

u=−K_{c}(I−L_{c}C)xₙ−(J_{c}+K_{c}L_{c})y+N_{c}r

By setting N_{c}=J_{c}+K_{c}L_{c} and M_{c}=BJ_{c} −(A−BK_{c})L_{c}, the current estimator/ regulator equations become

\dot{x}ₙ=(A−BK_{c})(I−L_{c}C)xₙ+(BJ_{c}−(A−BK_{c})L_{c})e (19)

u=−K_{c}(I−L_{c}C)xₙ+(J_{c}+K_{c}L_{c})e

where e=r−y. This form aligns well with classical feedback control where the error signal is the input to the controller and the input/output relationships for the reference input r and the controller input y are the same.

Given the current estimator/regulator control system in the foregoing equations, the objective is to solve for the J_{c}, K_{c}, L_{c}, M_{c} and N_{c} gain matrices so that these dynamics are the same as the desired controller dynamics. One way to achieve this objective is to assume that the states for the estimator/regulator and the states for the desired controller are both in the range space of a third state space system. When this condition holds, a transformation exists between each form of the controller and the corresponding gains can be determined just like as for the prediction estimator.

For example, define a new state vector z such that

xₙ=Tₙz (20)

where the Tₙ matrix reveals how the states of the current estimator can be written as a function of the new state vector.

Substituting produces

\dot{z}=Tₙ⁻¹(A−BK_{c}) (I−L_{c}C)Tₙz+Tₙ⁻¹((A−BK_{c}) L_{c}−BJ_{c}) y+Tₙ⁻¹M_{c}r (21)

u=−K_{c}(I−L_{c}C)Tₙz−(J_{c}+K_{c}L_{c})y+N_{c}r

By assuming that the foregoing sets of equations are equivalent yields the following relationships

T_{d}⁻¹A_{d}T_{d}=Tₙ⁻¹(A−BK_{c})(I−L_{c}C)Tₙ (22)

T_{d}⁻¹B_{d}=Tₙ⁻¹((A−BK_{c}) L_{c}−BJ_{c})

T_{d}⁻¹F_{d}=Tₙ⁻¹M_{c}

C_{d}T_{d}=−K_{c}(I−L_{c}C)Tₙ

D_{d}=−(J_{c}+K_{c}L_{c})

G_{d}=N_{c}

that can be determined by simply equating like matrices in the state space representations. Defining T₂ =T_{d}Tₙ⁻¹, the equations simplify to

A_{d}T₂+B_{d}C−T₂(A−BD_{d}C)−T₂BC_{d}T₂=0 (23)

J_{c}=C_{d}T₂(I−A⁻¹ (T₂⁻¹B_{d}−BD_{d)}C)⁻¹A⁻¹(T₂⁻¹B_{d}−BD_{d})−D_{d}

K_{c}=−C_{d}T₂(I−A^{31 1}(T₂⁻¹B_{d}−BD_{d})C)⁻¹

L_{c}=A⁻¹(T₂⁻¹B_{d}−BD_{d})

M_{c}=T₂⁻¹F_{d}

N_{c}=G_{d}

If a solution to the equation

A_{d}T₂+B_{d}C−T₂(A+BD_{d}C) −T₂BC_{d}T₂=0 (24)

exists for the T₂ matrix, then the J_{c}, K_{c}, L_{c}, M_{c} and N_{c} gain matrices can be computed using the foregoing equations. The T₂ matrix can be found using techniques for solving quadratic matrix equations as previously described. In general, there are many solutions to this quadratic matrix equation. For each solution, there are corresponding gain matrices that will generate the desired controller.

Also, notice that the equations for T₁ and T₂ are the same. This similarity between the prediction estimator design and the current estimator design occurs because of the transformation xₙ=(I−L_{c}C)⁻¹ x_{c} (I−L_{c}C)⁻¹ L_{c}y that was used to get the current estimator dynamics into an acceptable form. This transformation can be rewritten as

x_{c}−xₙ+L_{c}(y−Cxₙ)(25)

Comparing this equation with the one for the current estimator as illustrated in FIG. 2 suggests that xₙ₌ₓₚ. That is, the new state vector is really just the prediction estimator state vector.

4. Example

This section demonstrates the state space transformation method using a model of a hard disk drive and shows the many different gain combinations that exist for an estimator/regulator control system. For this system, velocity estimates are needed for the acceleration and deceleration portions of the seek trajectory. Starting with a desired controller, it is then mapped into equivalent prediction estimator/regulator and current estimator/regulator control systems. The gains for each controller can then be checked to ensure that the desired controller has been realized in the corresponding estimator/ regulator form.

The discrete-time model for this hard disk drive example can be written as

x[n+1]=Ax[n]+Bu[n] (26)

y[n]=Cx[n]

where

$$A = [ \begin{matrix}1 & 0.9980 & 0.1166 & 0.4056 \\ 0 & 0.9945 & 0.2030 & 1.137 \\ 0 & - 0.03120 & 0.4041 & 6.424 \\ 0 & 0 & 0 & 1\end{matrix} ] \\ B = [ \begin{matrix}0.4056 \\ 1.137 \\ 6.424 \\ 0\end{matrix} ] C = [ \begin{matrix}1 & 0 & 0 & 0\end{matrix} ] \qquad ( 27 )$$

The states for this model are (1) the read/write head position in units of track bits, (2) velocity in units of track bits/sample, (3) current in units of 20000 amps, and (4) torque bias in units of D/A voltage bits. This plant will serve as the system for which an estimator/regulator controller will be designed. The input to the system is a voltage command in units of D/A bits and the output from the system is the track position of the read/write head in units of A/D bits.

Research with voltage mode control of a hard disk drive uses the following controller

$$C ( z ) = \frac{0.2785 z ( z - 0.4260 ) ( {z}^{2} - 1.7812 z + 0.7957 )}{( z - 0.0009 ) ( z - 1 ) ( {z}^{2} - 0.0517 z + 0.1184 )} \qquad ( 28 )$$

to position the read/write head during seek mode. This controller contains an integrator, a second-order lead-lag term and a zero for added phase response. This transfer function form of the controller can be mapped into state space form and converted into equivalent prediction estimator/regulator and current estimator/regulator controllers using the preferred embodiment methods described in the foregoing. Matlab files that determine the estimator/regulator gains for a desired controller in state space form are provided in the Appendix.

The gains necessary to realize the desired controller as a prediction estimator/regulator are shown in the following table. The F_{d} and G_{d} matrices, which dictate the Mₚ and Nₚ terms, were arbitrarily set to zero for this example because they are not critical to the preferred embodiment solution procedure here. As the table shows there are seven different gain combinations that can produce the same controller; in particular, for the j^{th} gain set take Jₚ to be 0.2785, Kₚ to be the j^{th} row of Kp, Lₚ to be the j^{th} column of Lp, Mₚ to be the j^{th} column of Mp (all 0s), and Nₚ to be 0.

Table of gain sets for prediction estimator/regulator

| Jp = 0.2785 | | | | | | |
|---|---|---|---|---|---|---|
| Kp = | | | | | | |
| −0.1307 | 0.4318 | 0.1041 | 1.0000 | | | |
| −0.0973 | 0.4894 | 0.1205 | 1.0000 | | | |
| −0.2569 | 0.2138 | 0.0424 | 1.0000 | | | |
| −0.2298 | 0.4617 | 0.1222 | 1.0000 | | | |
| −0.2242 | 0.3010 | 0.0891 | 1.0000 | | | |
| −0.2119 | 0.3550 | 0.1074 | 1.0000 | | | |
| −0.2706 | 0.0967 | 0.0199 | 1.0000 | | | |
| Lp = | | | | | | |
| 1.2392 | 1.0553 | 1.9348 | 1.1291 | 1.5223 | 1.3384 | 2.2179 |
| 0.2784 | 0.2427 | 1.0068 | 0.5036 | 0.6139 | 0.5379 | 1.4308 |
| 0.1969 | 0.1274 | 0.4855 | 0.1659 | 0.4806 | 0.3183 | 1.4230 |
| 0.0079 | 0.0064 | 0.0542 | 0.0240 | 0.0215 | 0.0175 | 0.1475 |
| Mp = | | | | | | |
| 0 | 0 | 0 | 0 | 0 | 0 | 0 |
| 0 | 0 | 0 | 0 | 0 | 0 | 0 |
| 0 | 0 | 0 | 0 | 0 | 0 | 0 |
| 0 | 0 | 0 | 0 | 0 | 0 | 0 |
| Np = 0 | | | | | | |

The gains necessary to realize the foregoing controller as a current estimator/regulator are shown in the following table. Again, there are seven different gain combinations that can produce the same controller, and the F_{d} and G_{d} matrices, which dictate the and Nₚterms, were arbitrary set to zero for this example. Analogous to the prediction estimator/regulator, for the j^{th} gain set take J_{c} to be the j^{th} entry in the list Jc, K_{c} to be the j^{th}row of Kc, L_{c} to be the j^{th} column of Lc, M_{c} to be the j^{th} column of Mc (all 0s), and N_{c} to be 0.

Table of gain sets for current estimator/regulator

| Jc = 1.0e-010 * | | | | | | |
|---|---|---|---|---|---|---|
| −0.0018 | | | | | | |
| −0.0001 | | | | | | |
| −0.2871 | | | | | | |
| −0.0001 | | | | | | |
| −0.0111 | | | | | | |
| −0.0001 | | | | | | |
| −0.3925 | | | | | | |
| Kc = | | | | | | |
| 0.1478 | 0.4318 | 0.1041 | 1.0000 | | | |
| 0.1812 | 0.4894 | 0.1205 | 1.0000 | | | |
| 0.0215 | 0.2138 | 0.0424 | 1.0000 | | | |
| 0.0487 | 0.4617 | 0.1222 | 1.0000 | | | |
| 0.0543 | 0.3010 | 0.0891 | 1.0000 | | | |
| 0.0666 | 0.3550 | 0.1074 | 1.0000 | | | |
| 0.0079 | 0.0967 | 0.0199 | 1.0000 | | | |
| Lc = | | | | | | |
| 0.9984 | 0.8363 | 0.9997 | 0.6471 | 0.9986 | 0.8586 | 0.9997 |
| 0.1941 | 0.1903 | 0.8674 | 0.4656 | 0.4132 | 0.4105 | 1.0140 |
| 0.3766 | 0.2274 | 0.4068 | 0.0654 | 0.8793 | 0.5404 | 1.2547 |
| 0.0079 | 0.0064 | 0.0542 | 0.0240 | 0.0215 | 0.0175 | 0.1475 |
| Mc = | | | | | | |
| 0 | 0 | 0 | 0 | 0 | 0 | 0 |
| 0 | 0 | 0 | 0 | 0 | 0 | 0 |
| 0 | 0 | 0 | 0 | 0 | 0 | 0 |
| 0 | 0 | 0 | 0 | 0 | 0 | 0 |
| Nc = 0 | | | | | | |

5. Design method

The foregoing table of the hard disk drive example contains all of the gain sets for the current estimator/regulator implementation of the desired controller. Although each of the seven gain sets seems reasonable and exactly matches frequency and phase responses of the desired controller, some gain sets provide better hard drive head seek performance than other gain sets because the estimator/regulator control system is combined with a velocity profile technique to form an overall seek controller for a hard disk drive. The transition between algorithms in this seek controller can be parameterized as a function of the ratio Kc(1)/Kc(2); that is the ratio of the first component to the second component of the K_{c} vector of the gain set. When this ratio is small, the transition from the velocity profile technique to linear mode occurs early on in the seek and the performance suffers. However, if the ratio is too large, the transition from velocity profile technique to linear mode occurs late in the seek and the performance suffers too. As a result there is a tradeoff between the ratio value and the resulting seek performance.

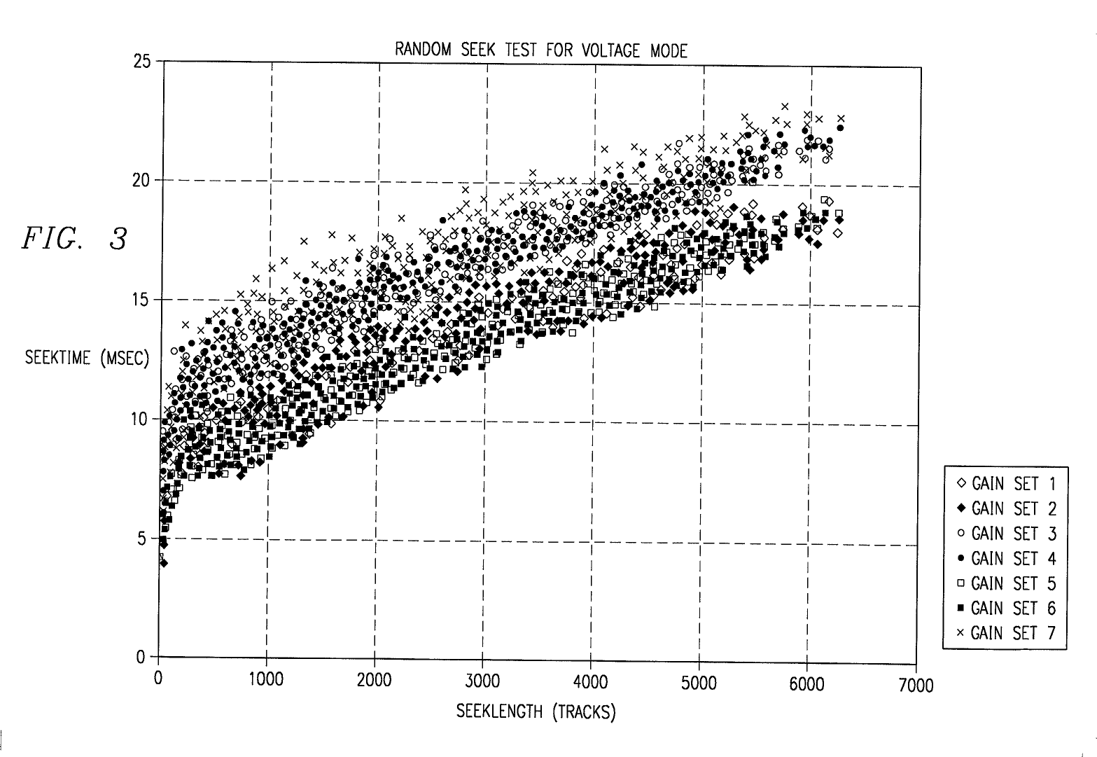

FIG. 3 illustrates results of seek performance of the hard disk drive example for the current estimator/regulator using each of the gain sets in the table. For each gain set, 1000 seeks were performed to randomly-selected destination tracks. In general, the gain set which provides the shortest seek times for all possible seek lengths is considered the best choice. For this particular example controller, the two gain sets with K_{c} equal to [0.0543 0.3010 0.0891 1.0000] or [0.0666 0.3550 0.1074 1.0000] provide the best overall performance. Notice that these two controllers have roughly the same kc(1)/kc(2) ratio value of 0.18.

Thus the preferred embodiments provide a design of an estimator/regulator for a desired controller which may also optimize with regard to an additional criterion. That is, translate a desired controller into all possible equivalent estimator/regulator implementations (all of which have the desired frequency and phase response) by using the previously described state space representation method, and then select from among these possible implementations using criteria distinct from the desired controller. For example, the cost of implementation could significantly vary among the possible implementations. Indeed, the efficiency of an implementation on a fixed-point digital signal processor (DSP) will depend upon features such as numerical dynamic range which vary among the possible implementations. Of course, without the state space representation method generating all possible equivalent implementations, there cannot be a real selection.

The overall design flow would be:

(1) express a desired controller and plant model in state space form.

(2) form “Hamiltonian” matrix from plant and desired controller matrices.

(3) determine invariant subspaces for Hamiltonian (eigenvector analysis).

(4) generate all transformations from desired controller to estimator/regulators by use of invariant subspaces.

(5) select an estimator/regulator from among possibilities.

6. Variations

The method for designing estimator/regulator control systems using state space representations can be modified in various ways. By expressing a target desired controller in state space form, it can be easily transformed into its estimator/regulator equivalent(s) using the Matlab functions provided in the Appendix or analogous procedures. Although the derivations used continuous-time equations to represent the desired controller and plant, they are equally valid for the discrete-time domain with a simple change of variables.

After deriving the solutions for the prediction estimator and the current estimator, they were shown to depend on the same quadratic matrix equation because the two estimators are related through a linear transformation. The hard disk drive example showed that many different gain combinations exist for a given desired controller, and this leads to various optimization possibilities for selection from the different gain combinations, including selection based on performance or cost.

7. Appendix

This section contains the Matlab functions required to implement the state space transformation method.

Matlab Function for Prediction Estimator/Regulator Control System

| | |
|---|---|
| 7. | Appendix |
| | This section contains the Matlab functions required to implement the state space |

transformation method.
Matlab Function for Prediction Estimator/Regulator Control System
function [Jp,Kp,Lp,Mp,Np] = ss2pestreg(Ad,Bd,Cd,Dd,Fd,Gd,A,B,C)
%SS2PESTREG State Space to Prediction Estimator/Regulator conversion
%

| | |
|---|---|
| % | [Jp,Kp,Lp,Mp,Np] = ss2pestreg(Ad,Bd,Cd,Dd,Fd,Gd,A,B,C) converts a desired |
| % | controller of the form |
| % | |

| | |
|---|---|
| % | xd = Ad*xd + Bd*y + Fd*r |
| % | u = Cd*xd + Dd*y + Gd*r |
| % | |

| | |
|---|---|
| % | into a prediction estimator/regulator equivalent of the form |
| % | |

| | |
|---|---|
| % | xp = (A−B*Kp−Lp*C)*xp + (Lp−B*Jp)*y + Mp*r |
| % | u = −Kp*xp − Jp*y + Np*r |
| % | |

| | |
|---|---|
| % | for a given plant of the form |
| % | |

| | |
|---|---|
| % | x = A*x + B*u |
| % | y = C*x |
| % | |

| | |
|---|---|
| % | The routine returns the prediction estimator and regulator gains |
| % | for the new controller. Since the set of equations for the unknowns |
| % | is nonlinear, the uniqueness of the solution is not guaranteed. |
| % | |
| % | NOTE: the ith set of gains is the ith column of Lp, the ith row of Kp and |
| % | the ith column of Mp |

%
% determine the dimension of the plant
n = size(Ad,1);
% form the special matrix, H
R = A+B*Dd*C;
S = B*Cd;
T = Bd*C;
U = Ad;
H = [R S;T U];
% compute the eigenvalues and eigenvectors
[v,d] = eig(H);
% index for all of the eigenvectors
index = [1:1:2*n];
% define the matrices
Kp = [];
Lp = [];
Mp = [];
% build the n-dimensional subspace of H
% determine all of the unique combinations of the eigenvectors
combos = combin(index,n);
numcombos = size(combos,1);
err = 0;
imag_limit = 1e-6;
for i=1 :numcombos,
vtmp = v(:,combos(i,:));
Tp = vtmp(1:n,1:n);
Td = vtmp(n+1:2*n,1:n);
if rank(Td) ˜= n

err = 1;

end
if rank(Tp) ˜= n

err = 1;

end
if err == 0

T1 = Td*inv(Tp);
% compute the estimator and regulator gains
Kptmp = −Cd*T1;
% zero out any small imaginary part of Kptmp
for i=1:n,

if abs(imag(Kptmp(i))) < imag_limit

Kptmp(i) = real(Kptmp(i));

end

end
Lptmp = inv(T1)*Bd−B*Dd;
% zero out any small imaginary part of Lptmp
for i=1:n,

if abs(imag(Lptmp(i))) < imag_limit

Lptmp(i) = real(Lptmp(i));

end

end
Mptmp = inv(T1)*Fd;
% zero out any small imaginary part of Mptmp
for i=1:n,

if abs(imag(Mptmp(i))) < imag_limit

Mptmp(i) = real(Mptmp(i));

end

end
% save any real gains
if(isreal(Kptmp) & isreal(Lptmp) & isreal(Mptmp))

Kp = [Kp; Kptmp];
Lp = [Lp Lptmp];
Mp = [Mp Mptmp];

end

else

err = 0;

```
  end
end
if size(Lp,2) == 0
  error(‘No real solutions were found for the prediction estimator/regulator.’)
end
% set the other gain matrices
Jp = −Dd;
Np = Gd;
Matlab Function for Current Estimator/Regulator Control System
function [Jc,Kc,Lc,Mc,Nc] = ss2cestreg(Ad,Bd,Cd,Dd,Fd,Gd,A,B,C)
%SS2CESTREG State Space to Current Estimator/Regulator conversion
%
```

| | |
|---|---|
| % | [Jc,Kc,Lc,Mc,Nc] = ss2cestreg(Ad,Bd,Cd,Dd,Fd,Gd,A,B,C) converts a desired |
| % | controller of the form |
| % | |

| | |
|---|---|
| % | xd = Ad*xd + Bd*y + Fd*r |
| % | u = Cd*xd + Dd*y + Gd*r |
| % | |

| | |
|---|---|
| % | into a current estimator/regulator equivalent of the form |

| | |
|---|---|
| % | xc = xp + Lc*(y−C*xp) |
| % | |
| % | xp = (A−B*Kc)*xc − B*Jc*y + Mc*r |
| % | u = −Kc*xc − Jc*y + Nc*r |
| % | |

| | |
|---|---|
| % | for a given plant of the form |
| % | |

| | |
|---|---|
| % | xA*x + B*u |
| % | y = C*x |

| | |
|---|---|
| % | The routine returns the current estimator and regulator gains |
| % | for the new controller. Since the set of equations for the unknowns |
| % | is nonlinear, the uniqueness of the solution is not guaranteed. |
| % | |
| % | NOTE: the ith set of gains is the ith row of Jc, the ith row of Kc, |

| | |
|---|---|
| % | the ith column of Lc and the ith column of Mc |

% determine dimensions
n = size(Ad,1);
m = size(Cd,1);
In = eye(n);
% form the special matrix, H
R = A+B*Dd*C;
S = B*Cd;
T = Bd*C;
U = Ad;
H = [R S;T U];
% compute the eigenvalues and eigenvectors
[v,d] = eig(H);
% index for all of the eigenvectors
index [1:1:2*n];
% define matrices
Jc = [];
Kc = [];
Lc = [];
Mc = [];
% build the n-dimensional subspace of H
% determine all of the unique combinations of the eigenvectors
combos = combin(index,n);
numcombos = size(combos,1);
err = 0;
imag_limit = 1e-6;
for i=1:numcombos,
vtmp = v(:,combos(i,:));
Tc = vtmp(1:n,1:n);
Td = vtmp(n+1:2*n,1:n);
if rank(Tc) ˜= n

err = 1;

end
if rank(Td) ˜= n

err = 1;

end
if err == 0

T2 = Td*inv(Tc);
% compute the estimator and regulator gains
Lctmp = inv(A)*(inv(T2)*Bd−B*Dd);
% zero out any small imaginary part of Lctmp
for i=1:n,

if abs(imag(Lctmp(i))) < imag_limit

Lctmp(i) = real(Lctmp(i));

end

end
Kctmp = −Cd*T2*inv(In−Lctmp*C);
% zero out any small imaginary part of Kctmp
for i=1:n,

if abs(imag(Kctmp(i))) < imag_limit

Kctmp(i) = real(Kctmp(i));

end

end
Jctmp = −Dd−Kctmp*Lctmp;
% zero out any small imaginary part of Jctmp
for i=1:m,

if abs(imag(Jctmp(i))) < imag_limit

Jctmp(i) = real(Jctmp(i));

end

end
Mctmp = inv(T2)*Fd;
% zero out any small imaginary part of Mctmp
for i=1:n,

if abs(imag(Mctmp(i))) < imag_limit

Mctmp(i) = real(Mctmp(i));

end

end
% save any real gains
if(isreal(Jctmp) & isreal(Kctmp) & isreal(Lctmp) & isreal(Mctmp))

Jc = [Jc; Jctmp];
Kc = [Kc; Kctmp];
Lc = [Lc Lctmp];
Mc = [Mc Mctmp];

end

else

err = 0;

```
  end
end
if size(Lc,2) ==0
  error(‘No real solutions were found for the current estimator/regulator.’)
end
% set the other gain matrices
Nc = Gd;
Combinatorial Algorithm
function [combos] = combin(set,r)
%COMBIN Combinatorial Algorithm
%
%
```

| | |
|---|---|
| % | [combos] = combin(set,r) computes all of the possible event combinations |
| % | for the points in a data set (without regard for order) for a prescribed |
| % | number of points in a particular event. |
| % | |
| % | combos is all of the possible point combinations. The number of |
| % | combinations will equal n!/r!/(n−r)!, where n is the number of unique |
| % | points in the data set. |
| % | |
| % | set is an array of points that form the data set |
| % | r is the number of points in a particular event |

```
% create the vector
combos = [];
% determine the unique points in the set
set = unique(set);
% return if there are no array of points
if isempty(set)
  return
end
% orient the set as a row vector
set = set(:)’;
% determine the number of unique points in the data set
n = size(set,2);
indices = [];
index = [];
% create first value
for i=1:r,
  index = [index i];
end
% generate the remaining samples
loop=1;
while loop
  indices = [indices; index];
j = r;
while (index(j) == n−r+j) & loop
```

j = j−1;
if j == 0

loop = 0;
j = 1; % assign j to a dummy, nonzero value

end

end
index(j) = index(j)+1;
for i=j+1:r,

index(i) = index(i−1) + 1;

end
end
combos = set(indices);

What is claimed is:

1. A method of estimator/regulator design, comprising the steps of:
(a) express a desired controller and plant model in state space form;
(b) form “Hamiltonian” matrix from plant and desired controller matrices;
(c) determine invariant subspaces for Hamiltonian; and
(d) generate all transformations from desired controller to estimator/regulators by use of invariant subspaces.

2. The method of claim 1, further comprising the step of:
(a) select an estimator/regulator from among possibilities
